(19) United States
(12) Patent Application Publication
(10) Pub. No.: US 2026/0292644 A1
(43) Pub. Date: Sep. 24, 2026

(54) METHOD AND USER EQUIPMENT FOR DETECTING AND ESCAPING FROM ISSUE CELL

(71) Applicant: MEDIATEK INC., Hsinchu City (TW)

(72) Inventors: Yung-Chun LIN, Hsinchu City (TW); Wan-Ting HUANG, Hsinchu City (TW)

(21) Appl. No.: 19/473,106

(22) PCT Filed: Oct. 18, 2024
(86) PCT No.: PCT/CN2024/125911

§ 371 Date: Oct. 6, 2025

Related U.S. Application Data
(60) Provisional application No. 63/591,787, filed on Oct. 20, 2023.

(51) Int. Cl. H04W 36/36; H04W 36/30

(52) U.S. Cl. CPC H04W 36/36; H04W 36/305

(57) ABSTRACT

A method for detecting an issue cell and escaping from the issue cell is provided. A connection with a Pcell is established. It is detected in a time window that there are no uplink (UL) packets, or no downlink (DL) packets, or no valid DL packets, or the frequency of a target secondary cell (Scell) or a target secondary cell group (SCG) repeatedly being added and removed from a serving cell is higher than a predefined frequency. It is determined that the Pcell is an issue cell. The issue cell is escaped from by handling a new reconfiguration message from the issue cell, or by handover or redirection, or by UE-triggered re-establishment or local release, or by modifying at least one of the measurement reports to skip the addition of the target Scell or the target SCG.

### CROSS REFERENCE TO RELATED APPLICATIONS

This application claims the benefit of U.S. Provisional Application No. 63/591,787, filed on Oct. 20, 2023, the entirety of which is incorporated by reference herein.

### BACKGROUND OF THE INVENTION

### Field of the Invention

The present invention relates to user equipment (UE), and, in particular, to a method and UE for detecting an issue cell and escaping from the issue cell.

### Description of the Related Art

Power saving is always the key consideration for mobile UE. When a UE is in radio resource control (RRC) CONNECTED mode, the UE will use lots of wireless resources and consume much power to keep synchronized with mobile networks.

To mitigate the unnecessary waste of UE power and precious wireless resources, both the network and the UE would try their best to keep the UE in RRC IDLE/INACTIVE mode as long as possible. However, sometimes the network does not release UE's RRC connection for a long time, even if there is no need for the UE to stay in RRC CONNECTED mode.

### BRIEF SUMMARY OF THE INVENTION

An embodiment of the present invention provides a method for detecting an issue cell and escaping from the issue cell. The method includes the following steps. A connection with a Pcell is established. It is detected that at least one of conditions in a time window is fulfilled. The conditions include no uplink (UL) packets, no downlink (DL) packets, no valid DL packets, and the frequency of a target secondary cell (Scell) or a target secondary cell group (SCG) repeatedly being added and removed from a serving cell is higher than a predefined frequency. It is determined that the Pcell is an issue cell. The issue cell is escaped by at least one of actions. The actions include handling a new reconfiguration message from the issue cell, handover or redirection, UE-triggered re-establishment or local release, and modifying at least one of the measurement reports to skip the addition of the target Scell or the target SCG.

According to the method described above, the step of escaping from the issue cell by handling the new reconfiguration message from the issue cell includes the following steps. Handover is performed in response to the new reconfiguration message that includes a handover command for Intra-radio access technology (RAT) or Inter-RAT. Alternatively, the new reconfiguration message may be directly ignored in response to the new reconfiguration message that includes the handover command or no handover command, so that the issue cell releases a radio resource control (RRC) connection. Alternatively, the new reconfiguration message is treated as an error or not supported in response to the new reconfiguration message that includes the handover command or no handover command, so that the UE-triggered re-establishment is performed.

According to the method described above, the step of escaping from the issue cell by handover or redirection includes the following step. Handover or redirection is triggered using A3/A4/A5/B1/B2 measurement reports.

According to the method described above, the step of escaping from the issue cell by handover or redirection includes the following step. A configured A2 measurement report with Pcell radio results lower than a threshold is triggered and is sent to the issue cell in order to trigger either an RRC connection release, redirection to either other cells, frequencies, or Inter-RAT, or a new configuration of the A3/A4/A5/B1/B2 measurement reports.

According to the method described above, the step of triggering a handover or redirection using the A3/A4/A5/B1/B2 measurement reports includes the following steps. Pcell radio results are faked by setting the Pcell radio results lower than first report thresholds. Alternatively, the Pcell radio results are faked and presented as much lower values. Alternatively, one or more Scell radio results are faked by setting the Scell radio results higher than second report thresholds. Alternatively, the Scell radio results are faked and presented as much higher values. Alternatively, the Scell radio results are faked and presented in a different order in the A3/A4/A5/B1/B2 measurement reports.

According to the method described above, the threshold includes A2-threshold.

According to the method described above, the first report thresholds include A5-threshold_1 or B2-threshold_1.

According to the method described above, the second report thresholds include A4-threshold and A5-threshold_1, or B1-threshold and B2-threshold_2.

According to the method described above, the step of escaping from the issue cell by UE-triggered re-establishment or local release includes the following steps. A configured A2measurement report with Pcell radio results lower than a threshold is triggered and is sent to the issue cell to initiate an RRC connection release. Alternatively, the UE-triggered re-establishment or the local release is performed at any time. Alternatively, the current serving cell is barred at a dedicated time to prevent it from camping on the issue cell again.

According to the method described above, the step of escaping from the issue cell by modifying at least one of the measurement reports to skip the addition of the target Scell includes the following steps. The target Scell in the measurement reports is skipped. Alternatively, the measurement reports on the target frequency that the target Scell is on are skipped. Alternatively, the target Scell in an A4 measurement report is skipped. Alternatively, the A4 measurement report on the target frequency that the target Scell is on is skipped.

According to the method described above, the step of escaping from the issue cell by modifying at least one of the measurement reports to skip the addition of the target SCG includes the following steps. The target SCG in the measurement reports is skipped. Alternatively, the measurement reports on the target frequency that the target SCG is on are skipped.

According to the method described above, the step of escaping from the issue cell by modifying at least one of the measurement reports to skip the addition of the target SCG for a New Radio (NR)-NR Dual Connectivity (NNDC) case includes the following steps. The target SCG in at least one A3 measurement report is skipped. Alternatively, the target SCG in at least one A4measurement report is skipped. Alternatively, the target SCG in at least one A5 measurement report is skipped.

According to the method described above, the step of escaping from the issue cell by modifying at least one of the measurement reports to skip the addition of the target SCG for a New Radio (NR)-NR Dual Connectivity (NNDC) case includes the following steps. At least one A3measurement report on the target frequency that the target SCG is on is skipped. Alternatively, at least one A4 measurement report on the target frequency that the target SCG is on is skipped. Alternatively, at least one A5 measurement report on the target frequency that the target SCG is on is skipped.

According to the method described above, the step of escaping from the issue cell by modifying at least one of the measurement reports to skip the addition of the target SCG for an E-UTRAN New Radio Dual Connectivity (ENDC) case or a New Radio E-UTRAN Dual Connectivity (NEDC) case includes the following steps. The target SCG in at least one B1 measurement report is skipped. Alternatively, the target SCG in at least one B2 measurement report is skipped.

According to the method described above, the step of escaping from the issue cell by modifying at least one of the measurement reports to skip the addition of the target SCG for an ENDC case or a NEDC case includes the following steps. At least one B1 measurement report on the target frequency that the target SCG is on is skipped. Alternatively, at least one B2 measurement report on the target frequency that the target SCG is on is skipped.

An embodiment of the present invention also provides user equipment (UE). The UE includes a processor. The processor establishes a connection with a Pcell. The processor detects that at least one of conditions is fulfilled in a time window. The conditions include no UL packets, no DL packets, no valid DL packets, and the frequency of a target Scell or a SCG, which is repeatedly added and removed from a serving cell, being higher than a predefined frequency. The processor determines the Pcell is an issue cell. The processor escapes from the issue cell by at least one of actions. The actions include handling a new reconfiguration message from the issue cell, handover or redirection, UE-triggered re-establishment or local release, and modifying at least one of the measurement reports to skip the addition of the target Scell or the target SCG.

According to the UE described above, the processor performs a handover in response to the new reconfiguration message comprising a handover command for Intra-radio access technology (RAT) or Inter-RAT. Alternatively, the processor directly ignores the new reconfiguration message in response to the new reconfiguration message that includes the handover command or no handover command, so that the issue cell releases an RRC connection with the UE. Alternatively, the processor treats the new reconfiguration message as an error or does not support it in response to the new reconfiguration message that includes the handover command or no handover command, so that the UE-triggered re-establishment is performed.

According to the UE described above, the processor triggers handover or redirection using A3/A4/A5/B1/B2 measurement reports.

According to the UE described above, the processor triggers a configured A2 measurement report with Pcell radio results lower than a threshold is triggered and is sent to the issue cell in order to trigger either an RRC connection release, redirection to either other cells, frequencies, or Inter-RAT, or a new configuration of the A3/A4/A5/B1/B2 measurement reports.

According to the UE described above, the processor fakes Pcell radio results by setting Pcell radio results lower than first report thresholds. Alternatively, the processor may fake the Pcell radio results and present them as much lower values. Alternatively, the processor may fake one or more Scell radio results by setting those results higher than the second report thresholds. Alternatively, the processor may fakes the Scell radio results and present them as much higher values. Alternatively, the processor may fake the Scell radio results and present them in a different order in the A3/A4/A5/B1/B2 measurement reports.

According to the UE described above, the processor triggers a configured A2 measurement report with Pcell radio results lower than the threshold of the issue cell to trigger an RRC connection release. Alternatively, the processor may perform the UE-triggered re-establishment or the local release at any time. Alternatively, the processor may bar the current serving cell at a dedicated time to prevent it from camping on the issue cell again.

According to the UE described above, the processor skips the target Scell in the measurement reports. Alternatively, the processor may skip the measurement reports on the target frequency that the target Scell is on. Alternatively, the processor may skip the target Scell in an A4 measurement report. Alternatively, the processor may skip the A4 measurement report on the target frequency that the target Scell is on.

According to the UE described above, the processor skips the target SCG in the measurement reports. Alternatively, the processor skips the measurement reports on the target frequency that the target SCG is on.

### BRIEF DESCRIPTION OF THE DRAWINGS

The present invention can be more fully understood by reading the subsequent detailed description and examples with references made to the accompanying drawings, wherein:

FIG. 1 shows a flow chart of a method for detecting an issue cell and escaping from the issue cell in accordance with some embodiments of the present invention;

FIG. 2 shows a detail flow chart of some embodiments of step S106 in FIG. 1 in accordance with some embodiments of the present invention;

FIG. 3 shows a detail flow chart of some embodiments of step S106 in FIG. 1 in accordance with some embodiments of the present invention;

FIG. 4 shows a flow chart of some embodiments of step S302 in FIG. 3 in accordance with some embodiments of the present invention;

FIG. 5 shows a detail flow chart of some embodiments of step S106 in FIG. 1 in accordance with some embodiments of the present invention;

FIG. 6 shows a detail flow chart of some embodiments of step S106 in FIG. 1 in accordance with some embodiments of the present invention;

FIG. 7 shows a detail flow chart of some embodiments of step S106 in FIG. 1 in accordance with some embodiments of the present invention;

FIG. 8 shows a detail flow chart of some embodiments of steps S700 and S702 in FIG. 7 for a New Radio (NR)-NR Dual Connectivity (NNDC) case in accordance with some embodiments of the present invention;

FIG. 9 shows a detail flow chart of some embodiments of steps S700 and S702 in FIG. 7 for an E-UTRAN New Radio Dual Connectivity (ENDC) case or a New Radio E-UTRAN Dual Connectivity (NEDC) case in accordance with some embodiments of the present invention; and

FIG. 10 shows a schematic diagram of a communication system 1000 in accordance with some embodiments of the present invention.

### DETAILED DESCRIPTION OF THE INVENTION

To make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ” . Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with

It should be noted that the technical features in different embodiments described in the following can be replaced, recombined, or mixed with one another to constitute another embodiment without depart in from the spirit of the present invention.

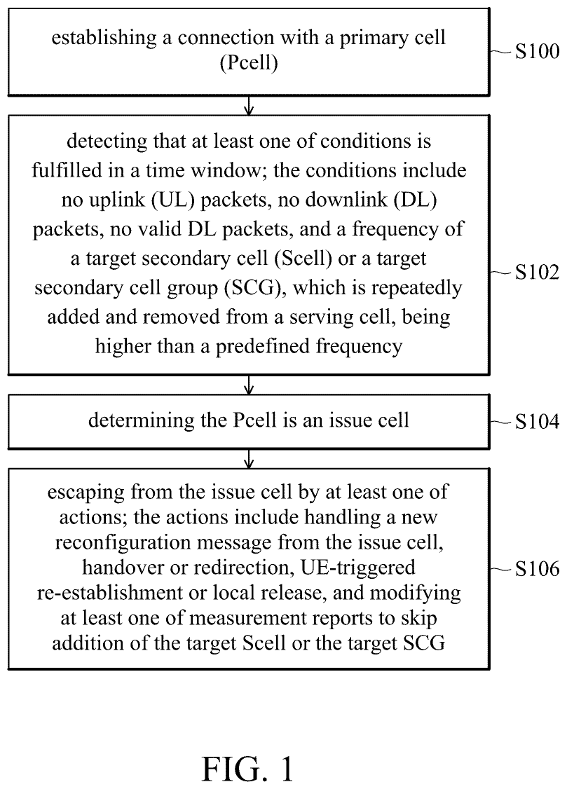

FIG. 1 shows a flow chart of a method for detecting an issue cell and escaping from the issue cell in accordance with some embodiments of the present invention. In some embodiments, the method for detecting the issue cell and escaping from the issue cell of the present invention is applied to user equipment (UE), such as a smart phone, a tablet, or a laptop, but the present invention is not limited thereto. The method for detecting the issue cell and escaping from the issue cell of the present invention includes the following steps. A connection with a Pcell is established (step S100). It is detected that at least one of conditions is fulfilled in a time window. The conditions include no uplink (UL) packets, no downlink (DL) packets, no valid DL packets, and the frequency of a target secondary cell (Scell) or a target secondary cell group (SCG), which is repeatedly added and removed from a serving cell, being higher than a predefined frequency (step S102). It is determined that the Pcell is an issue cell (step S104). The issue cell is escaped by at least one of actions. The actions include handling a new reconfiguration message from the issue cell, handover or redirection, UE-triggered re-establishment or local release, and modifying at least one of the measurement reports to skip the addition of the target Scell or the target SCG (step S106). In some embodiments, steps S100, S102, and S104 are the steps for detecting the issue cell. Step S106 is the step for escaping from the issue cell.

In step S100, a serving cell includes the Pcells. Moreover, the serving cell may also include other Scells or other SCGs, but the present invention is not limited thereto. In step S102, the conditions for the UE to determine that the Pcell is an issue cell may include at least one of the following conditions. For example, the UE detects that there are no uplink (UL) packets in a time window Tu. The time window Tu is for monitoring UE UL data sending. Alternatively, the UE detects no downlink (DL) packets in a time window Td. The time window Td is for monitoring UE DL data sending. Alternatively, the UE detects that no valid DL packets in the time window Tu or Td. In some embodiments, the valid DL packets are the packets that are specifically sent to the UE, rather than the broadcast ones.

Alternatively, the UE detects that the frequency of a target secondary cell (Scell) repeatedly being added and removed from the serving cell is higher than a predefined frequency in a time window Tr1. For example, it is assumed that the predefined frequency is equal to x. When the times that the target Scell is repeatedly added and removed is higher than x in the time window Tr1, the UE determines that the Pcell is an issue cell. Fifth, the UE detects that the occurrence frequency of a target SCG is repeatedly added and removed from the serving cell is higher than a predefined frequency in a time window Tr2. For example, it is assumed that the predefined occurrence frequency is equal to y. When the times that the target SCG is repeatedly added and removed is higher than y in the time window Tr2, the UE determines that the Pcell is an issue cell.

In step S106, the method to escape from the issue cell may include at least one of the following steps. For example, the UE escapes from the issue cell by specially handling a new reconfiguration message from the issue cell. Alternatively, the UE escapes from the issue cell by handover or redirection. Alternatively, the UE escapes from the issue cell by UE-triggered re-establishment or local release. Alternatively, the UE escapes from the issue cell by modifying at least one of the measurement reports to skip the addition of the target Scell. Alternatively, the UE escapes from the issue cell by modifying at least one of the measurement reports to skip the addition of the target SCG.

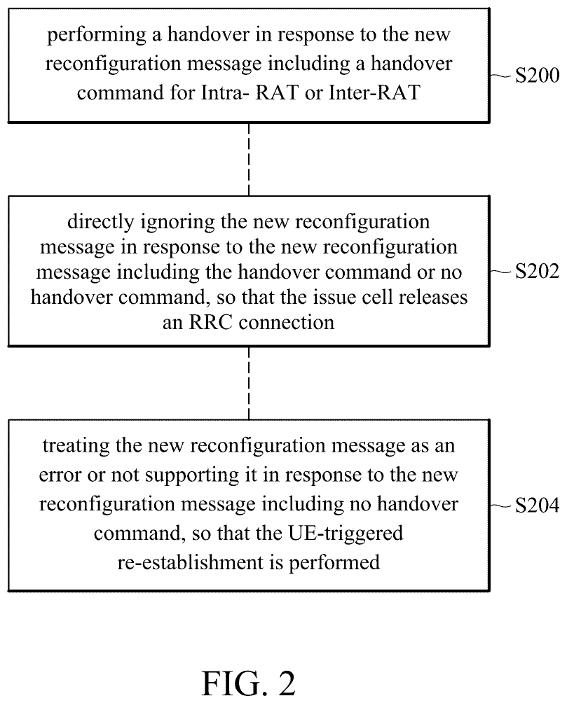

FIG. 2 shows a detail flow chart of some embodiments of step S106 in FIG. 1 in accordance with some embodiments of the present invention. In detail, FIG. 2 shows the detail flow chart of the step of escaping from the issue cell by handling the new reconfiguration message from the issue cell in step S106 in FIG. 1. As shown in FIG. 2, the method for detecting the issue cell and escaping from the issue cell of the present invention includes at least one of the following steps. Handover is performed in response to the new reconfiguration message that includes a handover command for Intra-radio access technology (RAT) or Inter-RAT (step S200). Alternatively, the new reconfiguration message is directly ignored in response to the new reconfiguration message that includes the handover command or no handover command, so that the issue cell releases a radio resource control (RRC) connection (step S202). Alternatively, the new reconfiguration message is treated as an error or not supported in response to the new reconfiguration message that includes the handover command or no handover command, so that the UE-triggered re-establishment is performed according to 3GPP specification (step S204). That is, any of steps S200 to S204 may be executed independently.

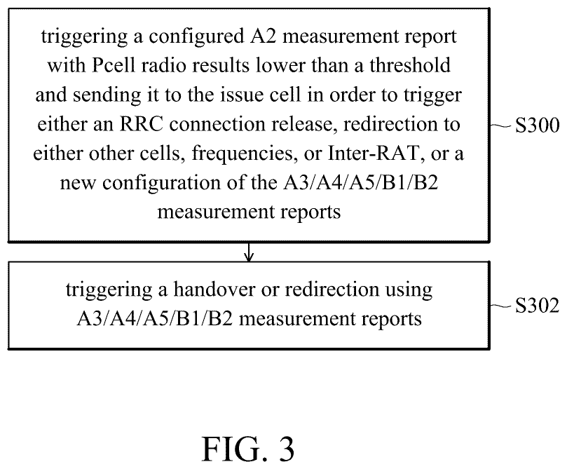

FIG. 3 shows a detail flow chart of some embodiments of step S106 in FIG. 1 in accordance with some embodiments of the present invention. In detail, FIG. 3 shows the detail flow chart of the step of escaping from the issue cell by handover or redirection in step S106 in FIG. 1. As shown in FIG. 3, the method for detecting the issue cell and escaping from the issue cell of the present invention includes the following steps. A configured A2 measurement report with Pcell radio results lower than a threshold is trigger and is sent to the issue cell in order to trigger either an RRC connection release, redirection to either other cells, frequencies, or inter-RAT, or a new configuration of the A3/A4/A5/B1/B2 measurement reports (step S300). Handover or redirection is triggered using A3/A4/A5/B1/B2 measurement reports (step S302). In some embodiments, step S300 may be optional, but the present invention is not limited thereto. In some embodiments, the threshold in step S300 may be an A2-threshold, but the present invention is not limited thereto.

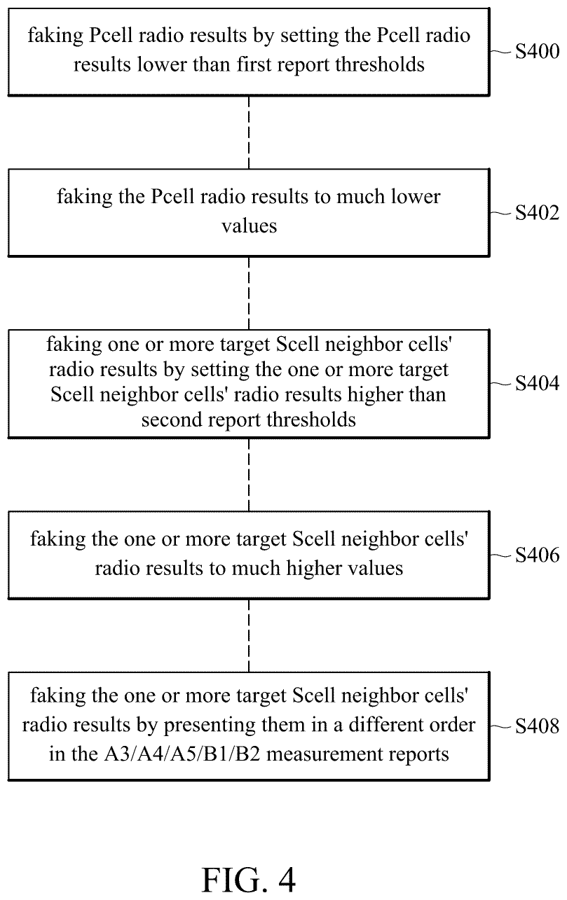

FIG. 4 shows a flow chart of some embodiments of step S302 in FIG. 3 in accordance with some embodiments of the present invention. FIG. 4 shows some embodiments of how the method for detecting the issue cell and escaping from the issue cell of the present invention to trigger handover or redirection using A3/A4/A5/B1/B2 measurement reports. The method for detecting the issue cell and escaping from the issue cell of the present invention includes at least one of the following steps. Pcell radio results are faked by setting the Pcell radio results lower than first report thresholds (step S400). Alternatively, the Pcell radio results are faked and presented as much lower values (step S402). Alternatively, one or more target Scell neighbor cells' radio results are faked by setting the target Scell neighbor cells' radio results higher than second report thresholds (step S404). Alternatively, the target Scell neighbor cells' radio results are faked and presented as much higher values (step S406). Alternatively, the target Scell neighbor cells' radio results are faked and presented in a different order in the A3/A4/A5/B1/B2 measurement reports (step S408). That is, any of steps S400 to S408 may be executed independently. In some embodiments, the first report thresholds in step S400 may include A5-threshold_1 or B2-threshold_1. The second report thresholds in step S404 may include A4-threshold and A5-threshold_1, or B1-threshold and B2-threshold_2.

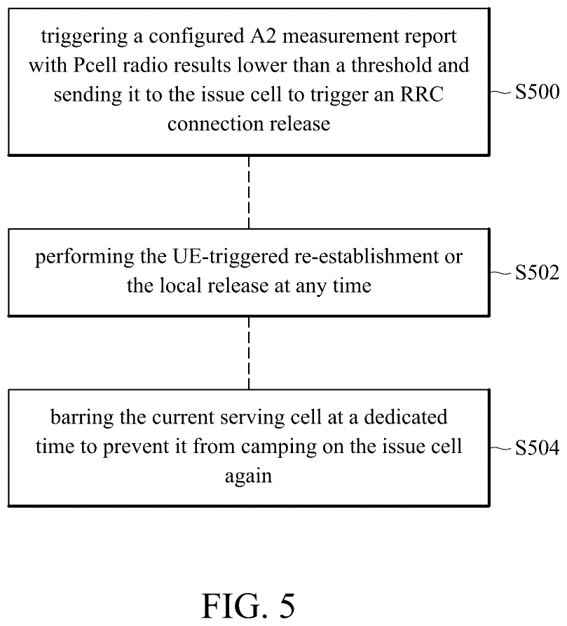

FIG. 5 shows a detail flow chart of some embodiments of step S106 in FIG. 1 in accordance with some embodiments of the present invention. In detail, FIG. 5 shows the detail flow chart of the step of escaping from the issue cell by UE-triggered re-establishment or local release in step S106 in FIG. 1. As shown in FIG. 5, the method for detecting the issue cell and escaping from the issue cell of the present invention includes at least one of the following steps. A configured A2 measurement report with Pcell radio results lower than a threshold is triggered and is sent to the issue cell to initial an RRC connection release (step S500). Alternatively, the UE-triggered re-establishment or the local release may be performed at any time (step S502). Alternatively, the current serving cell is barred at a dedicated time to prevent it from camping on the issue cell again (step S504). That is, any of steps S500 to S504 may be executed independently. In some embodiments, the method for detecting the issue cell and escaping from the issue cell of the present invention further triggers any cell early leave by re-establishment or by faking A2/A3/A4/A5/B1/B2 measurement reports.

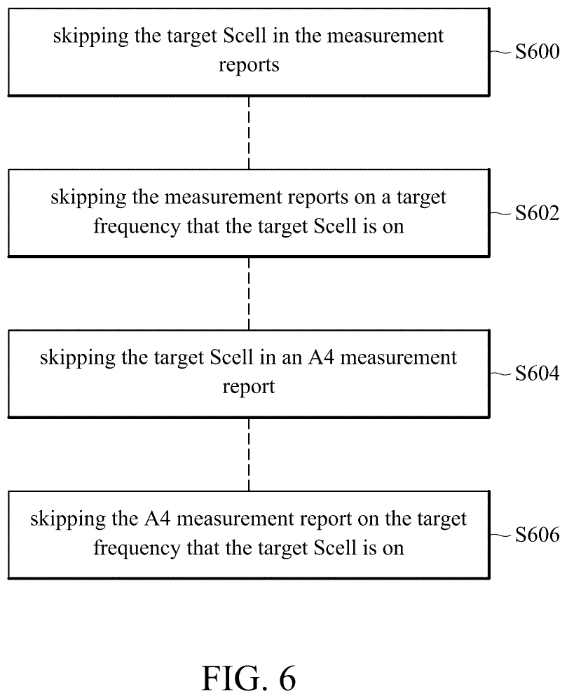

FIG. 6 shows a detail flow chart of some embodiments of step S106 in FIG. 1 in accordance with some embodiments of the present invention. In detail, FIG. 6 shows the detail flow chart of the step of escaping from the issue cell by modifying at least one of the measurement reports to skip the addition of the target Scell in step S106 in FIG. 1. As shown in FIG. 6, the method for detecting the issue cell and escaping from the issue cell of the present invention includes at least one of the following steps. The target Scell in the measurement reports is skipped (step S600). Alternatively, the measurement reports on the target frequency that the target Scell is on are skipped (step S602). Alternatively, the target Scell in an A4 measurement report is skipped (step S604). Alternatively, the A4 measurement report on the target frequency that the target Scell is on is skipped (step S606). That is, any of steps S600 to S606 may be executed independently. In some embodiments, steps S600~S606 are performed when the UE detects that the occurrence frequency of the target Scell repeatedly being added and removed from the serving cell is higher than a predefined frequency (e.g., x times in the time window Tr1) in step S102 in FIG. 1.

In some embodiments, when the measurement report is skipped, the method for detecting the issue cell and escaping from the issue cell of the present invention includes not sending or deleting the measurement reports. When the cell is skipped, the method for detecting the issue cell and escaping from the issue cell of the present invention includes not sending the target cells information in the measurement reports, or deleting the target cells from the measurement reports, or changing the reporting order of the target cells in the measurement reports. For example, when the UE reports order changed, the target cell or the other neighbor cells are adjusted in the measurement reports. In some embodiments, the measurement reports such as A3/A4/A5/B1/B2 measurement reports are sent to a network within 3 seconds prior than Scell or SCG addition.

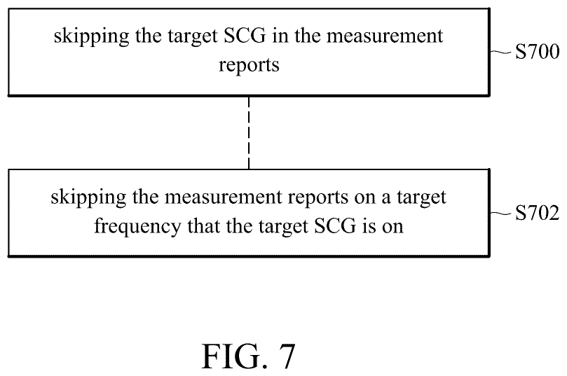

FIG. 7 shows a detail flow chart of some embodiments of step S106 in FIG. 1 in accordance with some embodiments of the present invention. In detail, FIG. 7 shows the detail flow chart of the step of escaping from the issue cell by modifying at least one of the measurement reports to skip the addition of the target SCG in step S106 in FIG. 1. As shown in FIG. 7, the method for detecting the issue cell and escaping from the issue cell of the present invention includes at least one of the following steps. The target SCG in the measurement reports is skipped (step S700). Alternatively, the measurement reports on the target frequency that the target SCG is on are skipped (step S702). That is, any of steps S700 and S702 may be executed independently. In some embodiments, steps S700 and S702 are performed when the UE detects that the frequency of the target SCG repeatedly being added and removed from the serving cell is higher than a predefined occurrence frequency in the time window Tr2 in step S102 in FIG. 1.

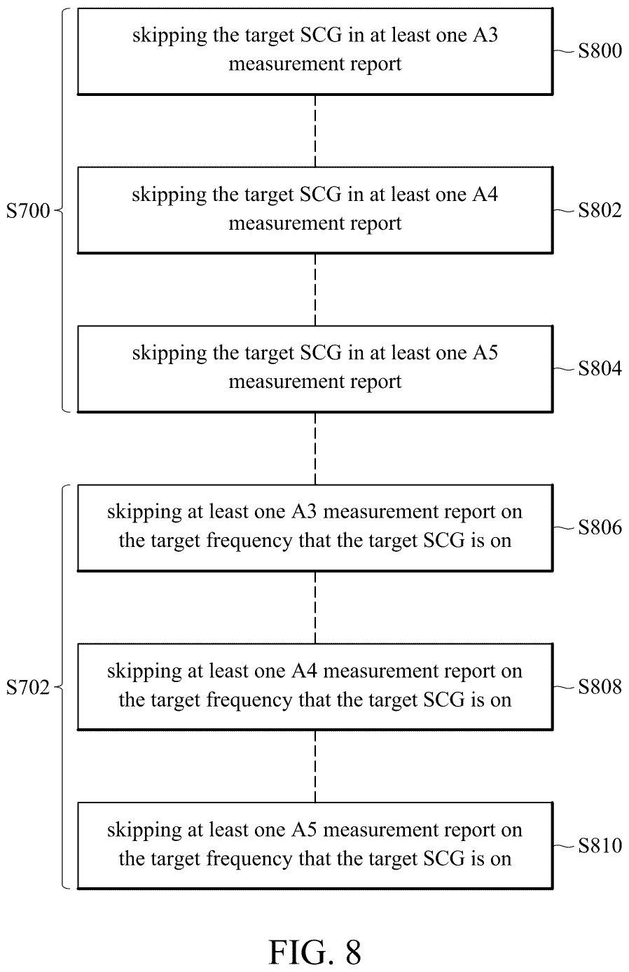

FIG. 8 shows a detail flow chart of some embodiments of steps S700 and S702 in FIG. 7 for a New Radio (NR)-NR Dual Connectivity (NNDC) case in accordance with some embodiments of the present invention. As shown in FIG. 8, step S700 in FIG. 7 includes at least one of the following steps. The target SCG in at least one A3 measurement report is skipped (step S800). Alternatively, the target SCG in at least one A4 measurement report is skipped (step S802). Alternatively, the target SCG in at least one A5 measurement report is skipped (step S804). That is, any of steps S800 to S804 may be executed independently. Step S702 in FIG. 7 includes at least one of the following steps. At least one A3 measurement report on the target frequency that the target SCG is on is skipped (step S806). Alternatively, at least one A4 measurement report on the target frequency that the target SCG is on is skipped (step S808). Alternatively, at least one A5 measurement report on the target frequency that the target SCG is on is skipped (step S810). That is, any of steps S806 to S810 may be executed independently.

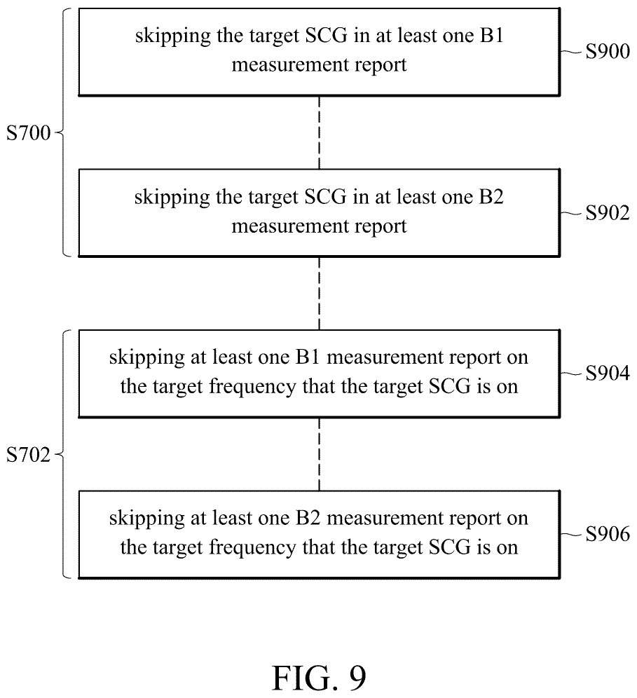

FIG. 9 shows a detail flow chart of some embodiments of steps S700 and S702 in FIG. 7 Connectivity (NEDC) case in accordance with some embodiments of the present invention. As shown in FIG. 9, step S700 in FIG. 7 includes at least one of the following steps. The target SCG in at least one B1 measurement report is skipped (step S900). Alternatively, the target SCG in at least one B2 measurement report is skipped (step S902). Step S702 in FIG. 7 includes the following steps. At least one B1 measurement report on the target frequency that the target SCG is on is skipped (step S904). Alternatively, at least one B2 measurement report on the target frequency that the target SCG is on is skipped (step S906). That is, any of steps S900 to S906 may be executed independently.

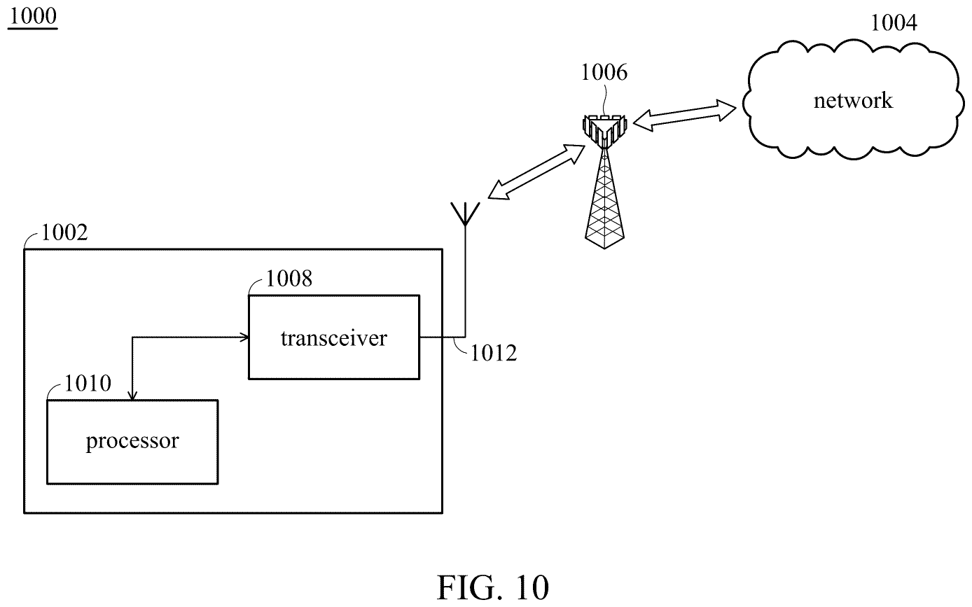

FIG. 10 shows a schematic diagram of a communication system 1000 in accordance with some embodiments of the present invention. As shown in FIG. 10, the communication system 1000 includes a UE 1002, a network 1004, and a base station 1006. In some embodiments, the UE 1002 may be a laptop, a tablet, or a smart phone, but the present invention is not limited thereto. In some embodiments, the UE 1002 is able to access the network 1004 through the base station 1006 to generate a serving cell. The serving cell at least includes a Pcell, but the present invention is not limited thereto. The UE 1002 is connected with the base station 1006 by Radio Resource Control (RRC) signaling, but the present invention is not limited thereto. In some embodiments, the base station 1006 may be a gNB, but the present invention is not limited thereto.

In some embodiments, the UE 1002 includes an antenna 1012, a transceiver 1008, and a processor 1010. The transceiver 1008 is electrically connected between the antenna 1012 and the processor 1010. The processor 1010 may be a modem, but the present invention is not limited thereto. In some embodiments, the UE 1002 further includes a memory (not shown) storing a plurality of codes. The processor 1010 reads the codes stored in the memory to execute the steps S100, S102, S104, and S106 in FIG. 1. In some embodiments, the processor 1010 escapes from the issue cell by handling a new reconfiguration message from the issue cell through step S200, or step S202, or step S204 in FIG. 2. In some embodiments, the processor 1010 escapes from the issue cell by handover or redirection through steps S300 and S302 in FIG. 3. In some embodiments, step S300 may be optional. In some embodiments, in order to escape from the issue cell by handover or redirection, the processor 1010 triggers handover or redirection using A3/A4/A5/B1/B2 measurement reports through step S400, or step S402, or step S404, or step S406, or step S408 in FIG. 4.

In some embodiments, the processor 1010 escapes from the issue cell by UE-triggered re-establishment or local release through step S500, or step S502, or step S504 in FIG. 5. In some embodiments, the processor 1010 escapes from the issue cell by modifying at least one of the measurement reports to skip the addition of the target Scell in step S600, or step S602, or step S604, or step S606 when the processor 1010 detects that the frequency of the target Scell repeatedly being added and removed from the serving cell is higher than a predefined frequency. In some embodiments, the processor 1010 escapes from the issue cell by modifying at least one of the measurement reports to skip the addition of the target SCG in step S700 or step S702 when the processor 1010 detects that the frequency of the target SCG repeatedly being added and removed from the serving cell is higher than a predefined frequency.

In some embodiments for the NNDC case, the processor 1010 skips the target SCG in the measurement reports through step S800, or step S802, or step S804. The processor 1010 skips the measurement reports on the target frequency that the target SCG is on through step S806, or step S808, or step S810. In some embodiments for the ENDC case or the NEDC case, the processor 1010 skips the target SCG in the measurement reports through step S900 or step S902. The processor 1010 skips the measurement reports on the target frequency that the target SCG is on through step S904 or step S906.

In some embodiments, when the measurement report is skipped, the method for detecting the issue cell and escaping from the issue cell and the UE 1002 of the present invention do not send or delete the measurement reports. When the cell (for example, the target Scell or the target SCG) is skipped, the method for detecting the issue cell and escaping from the issue cell and the UE 1002 of the present invention do not send, or delete, or report order changed in the measurement reports.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detecting an issue cell and escaping from the issue cell, comprising:
establishing a connection with a primary cell (Pcell);
detecting that at least one of conditions is fulfilled in a time window; wherein the conditions comprise no uplink (UL) packets, no downlink (DL) packets, no valid DL packets, and a frequency of a target secondary cell (Scell) or a target secondary cell group (SCG), which is repeatedly added and removed from a serving cell, being higher than a predefined frequency;
determining the Pcell is an issue cell; and
escaping from the issue cell by at least one of actions; wherein the actions comprise handling a new reconfiguration message from the issue cell, handover or redirection, UE-triggered re-establishment or local release, and modifying at least one of measurement reports to skip addition of the target Scell or the target SCG.

2. The method as claimed in claim 1, wherein the step of escaping from the issue cell by handling the new reconfiguration message from the issue cell comprises:
performing a handover in response to the new reconfiguration message comprising a handover command for Intra-radio access technology (RAT) or Inter-RAT; or
directly ignoring the new reconfiguration message in response to the new reconfiguration message comprising the handover command or no handover command, so that the issue cell releases a radio resource control (RRC) connection; or
treating the new reconfiguration message as an error or not supporting it in response to the new reconfiguration message comprising the handover command or no handover command, so that the UE-triggered re-establishment is performed.

3. The method as claimed in claim 1, wherein the step of escaping from the issue cell by handover or redirection comprises:
triggering a handover or redirection using A3/A4/A5/B1/B2 measurement reports.

4. The method as claimed in claim 3, wherein the step of escaping from the issue cell by handover or redirection further comprises:
triggering a configured A2 measurement report with Pcell radio results lower than a threshold to the issue cell in order to trigger either an RRC connection release, redirection to either other cells, frequencies, or Inter-RAT, or a new configuration of the A3/A4/A5/B1/B2 measurement reports.

5. The method as claimed in claim 3, wherein the step of triggering a handover or redirection using the A3/A4/A5/B1/B2 measurement reports comprises:
faking Pcell radio results by setting the Pcell radio results lower than first report thresholds; or
faking the Pcell radio results to much lower values; or
faking one or more target Scell neighbor cells' radio results by setting the one or more target
faking the one or more target Scell neighbor cells' radio results to much higher values; or
faking the one or more target Scell neighbor cells' radio results by presenting them in a different order in the A3/A4/A5/B1/B2 measurement reports.

6. The method as claimed in claim 4, wherein the threshold comprises A2-threshold.

7. The method as claimed in claim 5, wherein the first report thresholds comprise A5-threshold_1 or B2-threshold_1.

8. The method as claimed in claim 5, wherein the second report thresholds comprise A4-threshold and A5-threshold_1, or B1-threshold and B2-threshold_2.

9. The method as claimed in claim 1, wherein the step of escaping from the issue cell by UE-triggered re-establishment or local release comprises:
triggering a configured A2 measurement report with Pcell radio results lower than a threshold and sending it to the issue cell to trigger an RRC connection release; or
performing the UE-triggered re-establishment or the local release at any time; or
barring the current serving cell at a dedicated time to prevent it from camping on the issue cell again.

10. The method as claimed in claim 1, wherein the step of escaping from the issue cell by modifying at least one of the measurement reports to skip the addition of the target Scell comprises:
skipping the target Scell in the measurement reports; or
skipping the measurement reports on a target frequency that the target Scell is on; or
skipping the target Scell in an A4 measurement report; or
skipping the A4 measurement report on the target frequency that the target Scell is on.

11. The method as claimed in claim 1, wherein the step of escaping from the issue cell by modifying at least one of the measurement reports to skip the addition of the target SCG comprises:
skipping the target SCG in the measurement reports; or
skipping the measurement reports on a target frequency that the target SCG is on.

12. The method as claimed in claim 11, wherein the step of escaping from the issue cell by modifying at least one of the measurement reports to skip the addition of the target SCG for a New Radio (NR)-NR Dual Connectivity (NNDC) case comprises:
skipping the target SCG in at least one A3 measurement report; or
skipping the target SCG in at least one A4 measurement report; or
skipping the target SCG in at least one A5 measurement report.

13. The method as claimed in claim 11, wherein the step of escaping from the issue cell by modifying at least one of the measurement reports to skip the addition of the target SCG for a New Radio (NR)-NR Dual Connectivity (NNDC) case comprises:
skipping at least one A3 measurement report on the target frequency that the target SCG is on; or
skipping at least one A4 measurement report on the target frequency that the target SCG is on; or
skipping at least one A5 measurement report on the target frequency that the target SCG is on.

14. The method as claimed in claim 11, wherein the step of escaping from the issue cell by modifying at least one of the measurement reports to skip the addition of the target SCG for an E-UTRAN New Radio Dual Connectivity (ENDC) case or a New Radio E-UTRAN Dual Connectivity (NEDC) case comprises:
skipping the target SCG in at least one B1 measurement report; or
skipping the target SCG in at least one B2 measurement report.

15. The method as claimed in claim 11, wherein the step of escaping from the issue cell by modifying at least one of the measurement reports to skip the addition of the target SCG for an ENDC case or a NEDC case comprises:
skipping at least one B1 measurement report on the target frequency that the target SCG is on; or
skipping at least one B2 measurement report on the target frequency that the target SCG is on.

16. A user equipment (UE), comprising:
a processor, configured to:
establish a connection with a Pcell;
detect at least one of conditions is fulfilled in a time window; wherein the conditions comprise no UL packets, no DL packets, no valid DL packets, and a frequency of a target Scell or a SCG, which is repeatedly added and removed from a serving cell, being higher than a predefined frequency;
determine that the Pcell is an issue cell; and
escape from the issue cell by at least one of actions; wherein the actions comprise handling a new reconfiguration message from the issue cell, handover or redirection, UE-triggered re-establishment or local release, and modifying at least one of the measurement reports to skip the addition of the target Scell or the target SCG.

17. The UE as claimed in claim 16, wherein the processor is configured to:
perform a handover in response to the new reconfiguration message comprising a handover command for Intra-radio access technology (RAT) or Inter-RAT; or
directly ignore the new reconfiguration message in response to the new reconfiguration message comprising the handover command or no handover command, so that the issue cell releases an RRC connection with the UE; or
treat the new reconfiguration message as an error or to not support it in response to the new reconfiguration message comprising the handover command or no handover command, so that the UE-triggered re-establishment is performed.

18. The UE as claimed in claim 16, wherein the processor is configured to trigger handover or redirection using A3/A4/A5/B1/B2 measurement reports.

19. The UE as claimed in claim 18, wherein the processor is configured to:
trigger a configured A2 measurement report with Pcell radio results lower than a threshold and send it to the issue cell in order to trigger either an RRC connection release, redirection to either other cells, frequencies, or Inter-RAT, or a new configuration of the A3/A4/A5/B1/B2 measurement reports.

20. The UE as claimed in claim 18, wherein the processor is configured to:
fake Pcell radio results by setting Pcell radio results lower than first report thresholds; or
fake the Pcell radio results to much lower values; or
fake one or more target Scell neighbor cells' radio results by setting the one or more target Scell neighbor cells' radio results higher than second report thresholds; or
fake the one or more target Scell neighbor cells' radio results to much higher values; or
fake the one or more target Scell neighbor cells' radio results by presenting them in a different order in the A3/A4/A5/B1/B2 measurement reports.

21. The UE as claimed in claim 16, wherein the processor is configured to:
trigger a configured A2 measurement report with Pcell radio results lower than a threshold and send it to the issue cell to trigger an RRC connection release; or
perform the UE-triggered re-establishment or the local release at any time; or
bar the current serving cell at a dedicated time to prevent it from camping on the issue cell again.

22. The UE as claimed in claim 16, wherein the processor is configured to:
skip the target Scell in the measurement reports; or
skip the measurement reports on the target frequency that the target Scell is on; or
skip the target Scell in an A4 measurement report; or
skip the A4 measurement report on the target frequency that the target Scell is on.

23. The UE as claimed in claim 16, wherein the processor is configured to:
skip the target SCG in the measurement reports; or
skip the measurement reports on the target frequency that the target SCG is on.
